(19) United States
(12) Patent Application Publication
(10) Pub. No.: US 2004/0162824 A1
(43) Pub. Date: Aug. 19, 2004

(54) Method and apparatus for classifying a document with respect to reference corpus

(76) Inventor: Roland John Burns, Half Moon Bay, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/367,023

(22) Filed: Feb. 13, 2003

(51) Int. Cl. G06F 17/30

(52) U.S. Cl. 707/4

(57) ABSTRACT

A method and apparatus for classifying a document with respect to a reference corpus. The method includes receiving reference corpus information associated with the reference corpus. A first weighted characteristic vocabulary corresponding to the reference corpus is generated utilizing the reference corpus information. Additionally, document information associated with the document is received. A second weighted characteristic vocabulary corresponding to the document is generated utilizing the document information. The document may be classified with respect to the reference corpus utilizing the first weighted characteristic vocabulary and the second weighted characteristic vocabulary.

### BACKGROUND ART

Computers have become integral tools used in a wide variety of different applications, such as in finance and commercial transactions, computer-aided design and manufacturing, health care, telecommunication, education, etc. Computers are finding new applications as a result of advances in hardware technology and rapid development in software technology. Furthermore, the functionality of a computer system is dramatically enhanced by coupling these types of stand-alone devices together in order to form a networking environment. Within a networking environment, users may readily exchange files, share information stored on a common database, pool resources, and communicate via electronic mail (e-mail) and video teleconferencing. Furthermore, computers which are coupled to a networking environment like the Internet provide their users access to data and information from all over the world.

For example, a user of a computer connected to the Internet is able to search for and acquire data and information on an extremely wide variety of subjects and topics. One of the conventional ways for trying to locate specific information on the Internet is for a computer user to access and utilize an Internet search engine. For instance, a computer user may access an Internet search engine such as one of those found at “www.yahoo.com”, “www.google.com”, “www.lycos.com”, “www.altavista.com”, “www.wisenut.com”, or the like. Once at an Internet search engine web site, the computer user typically enters one or more specific key words in order to search the Internet for information regarding a particular subject. However, there are some disadvantages associated with this information gathering technique.

For example, one of the disadvantages associated with utilizing an Internet search engine to gather information is that the computer user may be deluged with an overwhelming amount (e.g., thousands) of “corresponding” Internet links returned by the Internet search engine that may or may not actually be relevant. It is appreciated that an Internet search may be narrowed in order to return less Internet links that may be more relevant. However, this also has the disadvantage of occasionally excluding relevant Internet links associated with information that would be desirable to the computer user.

Another technique for locating desirable information is to utilize the “card catalog” or Dewey Decimal Classification system usually implemented within a library. It is understood that these systems may be implemented on some type of computer system. A person may use either of these systems in order to aid him/her in locating books, periodicals or documents about a particular subject. However, there are disadvantages associated with these information searching techniques also. For example, occasionally there are documents that one will miss by utilizing either of these techniques.

The present invention may address one or more of the above issues.

### DISCLOSURE OF THE INVENTION

A method and apparatus for classifying a document with respect to a reference corpus. The method includes receiving reference corpus information associated with the reference corpus. A first weighted characteristic vocabulary corresponding to the reference corpus is generated utilizing the reference corpus information. Additionally, document information associated with the document is received. A second weighted characteristic vocabulary corresponding to the document is generated utilizing the document information. The document may be classified with respect to the reference corpus utilizing the first weighted characteristic vocabulary and the second weighted characteristic vocabulary.

### BRIEF DESCRIPTION OF THE DRAWINGS

FIGS. 1A and 1B are a flowchart of steps performed in accordance with embodiments of the present invention for classifying one or more documents with respect to one or more reference corpuses.

FIG. 2 is a diagram illustrating an exemplary mapping of different documents with respect to different reference corpuses in accordance with embodiments of the present invention.

FIG. 3 is a flowchart of steps performed in accordance with embodiments of the present invention for classifying a document with respect to a reference corpus.

FIG. 4 is a block diagram of an exemplary network that may be utilized in accordance with embodiments of the present invention.

FIG. 5 is a block diagram of an exemplary computer system that may be used in accordance with embodiments of the present invention.

### MODES FOR CARRYING OUT THE INVENTION

Reference will now be made in detail to embodiments of the invention, examples of which are illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the present invention.

### EXEMPLARY OPERATIONS IN ACCORDANCE WITH THE PRESENT INVENTION

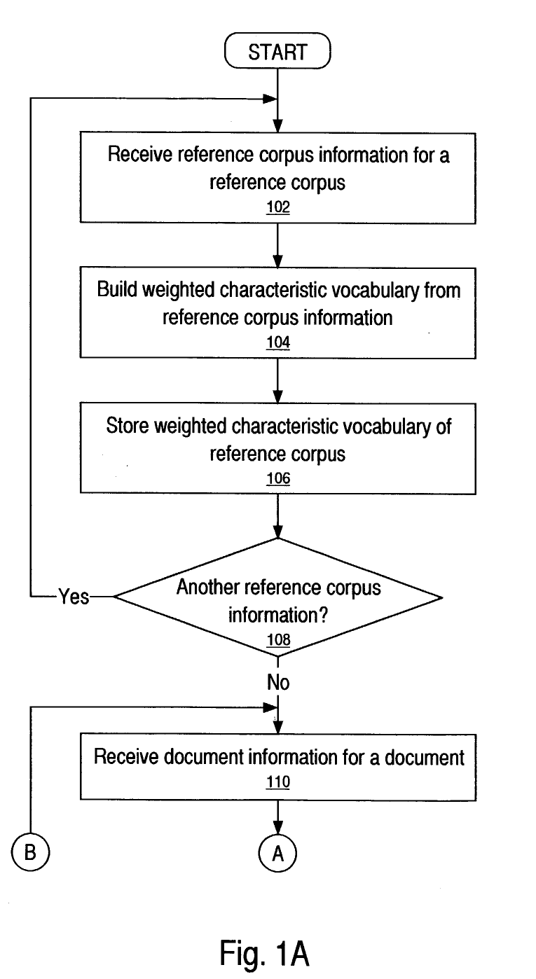

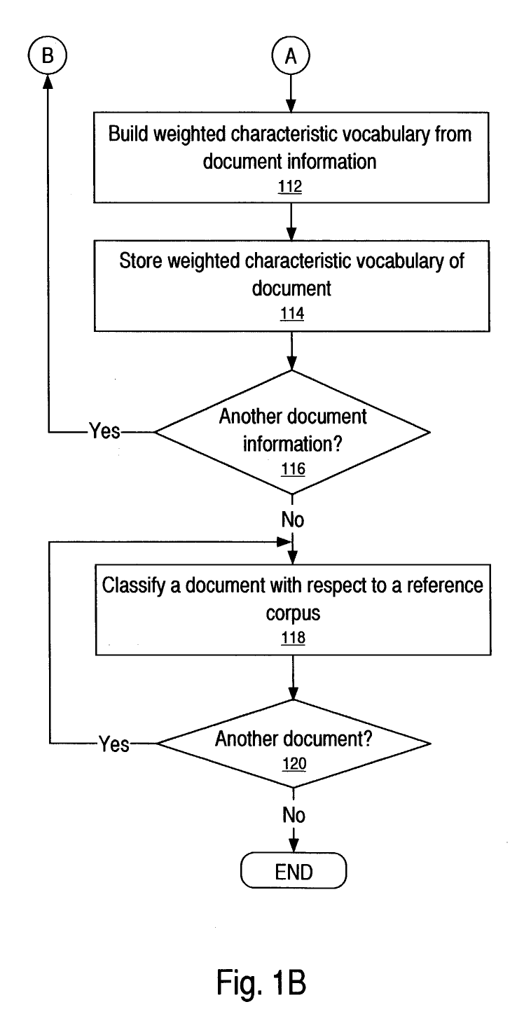

FIGS. 1A and 1B are a flowchart 100 of steps performed in accordance with embodiments of the present invention for classifying documents (or articles) with respect to one or more reference corpuses. Flowchart 100 includes processes which, in some embodiments, are carried out by a processor(s) and electrical components under the control of computer readable and computer executable instructions. The computer readable and computer executable instructions may reside, for example, in data storage features such as computer usable volatile memory, computer usable non-volatile memory and/or computer usable mass data storage. However, the computer readable and computer executable instructions may reside in any type of computer readable medium. Although specific steps are disclosed in flowchart 100, such steps are exemplary. That is, the present embodiment is well suited to performing various other steps or variations of the steps recited in FIGS. 1A and 1B. Within the present embodiment, it should be appreciated that the steps of flowchart 100 may be performed by software, by hardware or by any combination of software and hardware.

The present embodiment provides a method for classifying documents (or articles) with respect to one or more reference corpuses. For example, when information (e.g., a table of contents, index, etc.) associated with a reference corpus is received (or retrieved), a weighted characteristic vocabulary is generated using the reference corpus information and subsequently stored. It is appreciated that the weighted characteristic vocabulary may include, but is not limited to, a determination of the specific words that exist within the reference corpus information along with the number of instances each word exists. As such, the weighted characteristic vocabulary of the reference corpus information may be utilized as a “representation” of the subject matter associated with the reference corpus. This process may then be repeated for each desired reference corpus.

Next, when information associated with a document (or article) is received, a weighted characteristic vocabulary is generated using the document information and later stored. It is appreciated that the document weighted characteristic vocabulary may be utilized as a “representation” of the subject matter associated with the document. This document processing may be repeated for each desired document (or article). Next, a document is classified with respect to a reference corpus utilizing their respective stored weighted characteristic vocabularies. In this manner, a determination may be made as to which reference corpus is most closely related to the document with respect to their subject matter. The classification process may be repeated for each desired document (or article).

At step 102 of FIG. 1A, reference corpus information corresponding to a reference corpus is received or retrieved in order to be processed as illustrated by flowchart 100. It is noted that the reference corpus of step 102 is well suited to be implemented in a wide variety of ways. For example, the reference corpus (or large collection of reference material) may include, but is not limited to, a journal which may include a portion of or the entire collection of a particular periodical or magazine, a collection of literature from a particular author and/or about a specific subject, a portion of or the entire collection of newspapers from a newspapers publisher, a related collection of documents or articles, any type of reference material, a collection of periodicals, a collection of magazines, and the like.

Furthermore, it is understood that the reference corpus information of step 102 is well suited to be implemented in diverse ways. For example, the reference corpus information may be implemented as, but is not limited to, a table of contents or a combination of tables of contents associated with the contents of the reference corpus, an index or a combination of indexes associated with the reference corpus, an abstract associated with the reference corpus, a combination of abstracts associated with the reference corpus, a summary associated with the reference corpus, a combination of summaries associated with the reference corpus, and/or the contents of the reference corpus.

In step 104, a weighted characteristic vocabulary (or weighted word frequency) is built or generated utilizing the reference corpus information associated with the reference corpus. It is understood that the weighted characteristic vocabulary of step 104 is well suited to be implemented in a wide variety of ways. For example, as part of determining the weighted characteristic vocabulary, for every “significant” word stem (e.g., irrespective of its part of speech, tense or other grammatical variants) of the reference corpus information, two numbers may be initially calculated. It is noted that “significant” may mean the exclusion of prepositions, articles, possessives, etc. that carry no indication of subject matter.

The first number that may be calculated is the local relative frequency (RF) value. The local relative frequency in the reference corpus information is determined by the number of times a word “x” occurs within the reference corpus information divided by the number of words within the reference corpus information. The second number that may be calculated is the “global” relative frequency (GF) value. The global relative frequency is determined by the number of times word “x” occurs within a “global” collection divided by the number of words in the global collection. It is noted that the “global” collection may include a wide variety of things. For example, the “global” collection may include, but is not limited to, the “universe” of all known articles or documents in a particular language (e.g., English, Italian, Spanish, French, German, Japanese, etc.), the contents of the reference corpus, a combination of reference corpuses, and the like. Subsequently, the significance of each word stem is calculated by dividing RF by GF and then normalizing that result by dividing it by the square root of the length of the reference corpus information (LRCI). This significance calculation is shown by the following relationship:

$$\frac{( RF / GF )}{{( LRCI )}^{0.5}}$$

Once the significance of each word stem is calculated, all of those numbers may then be combined together as a representation of the subject matter or content corresponding to the reference corpus. The resulting information may subsequently be utilized to provide a measure of the similarity of the reference corpus and a document with respect to their subject matter.

It is understood that there are alternative ways for determining the weighted characteristic vocabulary (or weighted word frequency) associated with the reference corpus information at step 104. For example, rather than using every significant word as described herein, every significant word and its synonyms may be used. Alternatively, every significant word and its synonyms and/or its antonyms may be used. In other embodiments, every word of the reference corpus information (significant or not) may be used. However, this technique may not provide as accurate of a measurement of the reference corpus information. In yet other embodiments, a word co-occurring technique may be utilized that bundles related or co-occurring terms into concepts (e.g., fuzzy sets of words with correspondingly varying degrees of synonymity) thereby increasing the precision of the technique in the face of synonyms and temporal vocabulary drift. Within still other embodiments, a weighted word vector associated with the reference corpus may be determined utilizing the reference corpus information. It is noted that any linguistic weighted characteristic vocabulary technique (or weighted word frequency technique) may be implemented as part of step 104.

At step 106 of FIG. 1A, the weighted characteristic vocabulary (or weighted word frequency) associated with the reference corpus may be stored utilizing any type of memory device. It is appreciated that the memory device utilized at step 106 may include, but is not limited to, random access memory (RAM), static RAM, dynamic RAM, read only memory (ROM), programmable ROM, flash memory, erasable programmable read only memory (EPROM), electrically erasable programmable read only memory (EEPROM), disk drive (e.g., hard disk drive), diskette, and/or magnetic or optical disk, e.g., compact disc (CD), digital versatile disc (DVD), and the like. It is noted that the weighted characteristic vocabulary corresponding to the reference corpus may be stored so that it may be subsequently used within flowchart 100.

At step 108, a determination is made as to whether there is another reference corpus information associated with another reference corpus to be received or retrieved in order to be processed as illustrated by flowchart 100. If it is determined at step 108 that there is another reference corpus information to receive or retrieved, the present embodiment proceeds to the beginning of step 102. In this manner, a weighted characteristic vocabulary (or weighted word frequency) may be generated for each desired reference corpus from their corresponding reference corpus information. However, if it is determined at step 108 that there is not another reference corpus information to receive or retrieved, the process proceeds to step 110.

In step 110 of FIG. 1A, document (or article) information corresponding to a document (or article) is received or retrieved in order to be processed by flowchart 100. It is noted that the document of step 110 is well suited to be implemented in a wide variety of ways in accordance with the present embodiment. For example, the document may include, but is not limited to, an article or document from a reference corpus, an article or document from a journal (e.g., periodical or magazine), a newspaper article, a book, a thesis, and the like.

Additionally, it is understood that the document (or article) information of step 110 is well suited to be implemented in diverse ways. For example, the document information may be implemented as, but is not limited to, the contents of the document, a table of contents or a combination of tables of contents associated with the contents of the document, an index or a combination of indexes associated with the document, an abstract associated with the document, and/or a summary associated with the document.

In step 112 of FIG. 1 B, a weighted characteristic vocabulary (or weighted word frequency) is generated or built utilizing the document information associated with the document. It is appreciated that the weighted characteristic vocabulary of step 112 is well suited to be implemented in a wide variety of ways. For example, as part of determining the weighted characteristic vocabulary using the document information, for every “significant” word stem (e.g., irrespective of its part of speech, tense or other grammatical variants) of the document information, two numbers may be initially calculated. It is noted that “significant” may mean the exclusion of prepositions, articles, possessives, etc. that carry no indication of subject matter.

The first number that may be calculated is the local document relative frequency (DRF) value. The local document relative frequency in the document information is determined by the number of times a “significant” word occurs within the document information divided by the number of words within the document information. The second number that may be calculated is the document “global” relative frequency (DGF) value. The document global relative frequency is determined by the number of times word “x” occurs within the “global” collection divided by the number of words in the global collection. It is understood that the global collection is the same as the one utilized to determine the “global” relative frequency (GF) value herein. As such, it is noted that if word “x” exists within both the document information and the reference corpus information, the DGF and the GF associated with word “x” will be the same calculated number. Subsequently, the significance of each word stem is calculated by dividing DRF by DGF and then normalizing that result by dividing it by the square root of the length of the document information (LDI). This significance calculation is shown by the following relationship:

$$\frac{( DRF / DGF )}{{( LDI )}^{0.5}}$$

Once the significance of each word stem is calculated, all of those numbers may then be combined together as a representation of the subject matter or content corresponding to the document (or article). The resulting information may subsequently be utilized to provide a measure of the similarity of the document and a reference corpus with respect to their subject matter.

It is noted that there are alternative ways for determining the weighted characteristic vocabulary (or weighted word frequency) associated with the document information at step 112. For example, rather than using every “significant” word of the document information as described herein, every significant word and its synonyms may be used. Alternatively, every significant word and its synonyms and/or its antonyms may be used. Within other embodiments, every word of the document information (significant or not) may be used. However, this technique may not provide as accurate of a measurement of the document information. In yet other embodiments, a word co-occurring technique may be utilized that bundles related or co-occurring terms into concepts (e.g., fuzzy sets of words with correspondingly varying degrees of synonymity) thereby increasing the precision of the technique in the face of synonyms and temporal vocabulary drift. Within still other embodiments, a weighted word vector associated with the document may be determined utilizing the document information. It is understood that any linguistic weighted characteristic vocabulary technique or weighted word frequency technique may be implemented as part of step 112.

At step 114 of FIG. 1B, the weighted characteristic vocabulary (or weighted word frequency) associated with the document may be stored utilizing any type of memory device. It is appreciated that the memory device utilized at step 114 may include, but is not limited to, RAM, static RAM, dynamic RAM, ROM, programmable ROM, flash memory, EPROM, EEPROM, disk drive (e.g., hard disk drive), diskette, and/or magnetic or optical disk (e.g., CD, DVD, and the like). It is noted that the weighted characteristic vocabulary corresponding to the document may be stored so that it may be subsequently used within flowchart 100.

In step 116, a determination is made as to whether there is another document information associated with another document to be received or retrieved in order to be processed by flowchart 100. If it is determined at step 116 that there is another document information to be received or retrieved, the present embodiment proceeds to the beginning of step 110. In this manner, a weighted characteristic vocabulary or weighted word frequency may be generated for each desired document from their corresponding document information. However, if it is determined at step 1 16 that there is not another document information to be received or retrieved, the process proceeds to step 118.

At step 118 of FIG. 1B, a determination is made as to which reference corpus is most closely related to a document (or article) with respect to their subject matter or content. It is appreciated that step 118 is well suited to be implemented in a wide variety of ways. For example, a stored weighted characteristic vocabulary (or weighted word frequency) associated with a document may be compared to the stored weighted characteristic vocabularies associated with reference corpuses in order to determine which reference corpus is most similar to the document with respect to their subject matter or content.

One way of mapping or classifying a document to a reference corpus at step 118 may be to determine the distance between the document's weighted characteristic vocabulary and the stored weighted characteristic vocabulary associated with a reference corpus. The distance(s) may include, but is not limited to, Euclidean distance, Manhattan (also known as City Block) distance, sum (abs (xᵢ−yᵢ)), and the like. It is noted that in order to perform these types of distance calculations, one conceptually constructs a vector with an entry assigned to each word/term along with the frequency in that entry, and then performs conventional vector calculations on them. In practice this means that the vector can have as many entries as there are words/terms in the language (e.g., roughly 3 million for the English language). Therefore, for a realistic document or reference corpus (except a dictionary), this typically results in a vector having the vast majority of its entries being zero (commonly referred to as a sparse array). However, there are different techniques for dealing with spare arrays.

For example, a characteristic vocabulary of a document or reference corpus may be stored as an array having two columns and as many rows as there are terms. In order to calculate the Euclidean distance, each entry is taken in turn from a first array (or table) associated with a characteristic vocabulary (e.g., of a document) and a determination is made as to whether that term occurs within a second array (or table) associated with another characteristic vocabulary (e.g., of a reference corpus). It is appreciated that one way to determine whether a entry occurs within the second array is to store it as a hash table. If the term exists within the second array, the square of the difference in relative frequencies is calculated and then added to a running total. At the end, the square root of the running total is determined resulting in the Euclidean distance. Likewise, to calculate the City Block distance, the difference in relative frequency values is used. (ensuring it is positive) and added together to produce the City Block distance. In this manner, the document or article may be classified with respect to the reference corpus. Furthermore, it is understood that the reference corpus provides a proxy for a subject classification. The document may be classified in this manner with respect to one or more reference corpuses. It is noted that a match between the document and a reference corpus in this manner provides a classification based on statistics, without really having to “understand” the document.

In step 120, a determination is made as to whether there is another document to be classified by flowchart 100. If it is determined at step 120 that there is another document to be classified, the present embodiment proceeds to the beginning of step 118. In this fashion, each desired document may be classified with respect to one or more reference corpuses. However, if it is determined at step 120 that there is not another document to be classified, the process, in accordance with some embodiments, exits flowchart 100.

It is noted that flowchart 100 includes, but is not limited to, the functionality of: 1) generating a weighted characteristic vocabulary associated with a document or article; 2) generating a weighted characteristic vocabulary associated with a reference corpus; and 3) utilizing a “global” collection as the reference by which the weighted significance of each word is determined with regard to a weighted characteristic vocabulary.

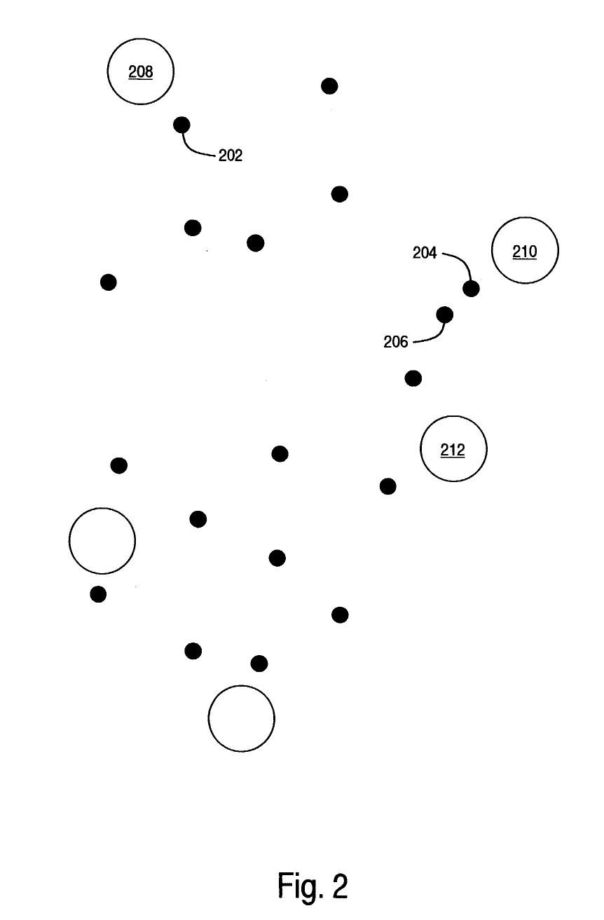

FIG. 2 is a diagram illustrating an exemplary mapping 200 of different documents (or articles) with respect to different reference corpuses in accordance with embodiments of the present invention. It is understood that mapping 200 may be produced from information (e.g., weighted characteristic vocabularies, distances, etc.) that may be generated by flowchart 100. It is noted that the word “document” and the term “reference corpus” of the present embodiment may be implemented in any manner described herein, but are not limited to such implementations.

Within mapping 200, each dot (e.g., 202, 204 and 206) represents a different document while each circle (e.g., 208, 210 and 212) represents a different reference corpus. Therefore, when a document is classified at step 118 of flowchart 100, its position and distance from one or more reference corpuses may be determined. For example, the closer a document is located to a reference corpus, the more similar (or greater affinity) their respective subject matter or content are to each other. Additionally, the closer a document is located to another document, the more similar their respective subject matter or content are to each other. Conversely, the farther away a document is located from a reference corpus, the less similar (or less affinity) their respective subject matter or content are to each other. Moreover, the farther away a document is located from another document, the less similar their respective subject matter or content are to each other.

For example, as shown within mapping 200, document 202 is located a shorter distance from reference corpus 208 than it is located from reference corpus 210. As such, the subject matter of document 202 is understood to be more similar to (or have greater affinity to) the subject matter or content of reference corpus 208 than it has with the subject matter or content of reference corpus 210. Additionally, document 204 is located closer to document 206 than it is to document 202. Therefore, the subject matter or content of document 204 is understood to have a greater affinity to the subject matter of document 206 than it has with the subject matter of document 202.

There are different applications that may be implemented with the information represent by mapping 200 of FIG. 2. For example, given a particular document, a determination may be made as to which reference corpuses are most closely related to (or cover) the same subject matter or content of that particular document. Within another embodiment, given a set of reference corpuses, a list of articles (or documents) may be generated that are likely to be within the domain of interest (or subject matter) of those reference corpuses, irrespective of where the articles (or documents) were actually published. This could be used as a custom “alert” service or as a resource that lists all of the articles (or documents) in other reference corpuses that might be of interest to the readers of a particular reference corpus. Within yet another embodiment, each article in a reference corpus may be identified as to whether it “fits” into the historical interests of that reference corpus, and whether it would be better published elsewhere. Within still another embodiment, given a reference corpus, a list of reference corpuses may be generated that are most closely related to (or cover) the same subject matter or content of that particular reference corpus. These are a few of the exemplary embodiments that may be implemented utilizing information derived from flowchart 100. As such, embodiments in accordance with the present invention may provide more accurate ways of locating relevant documents (or articles) associated with a particular topic or subject.

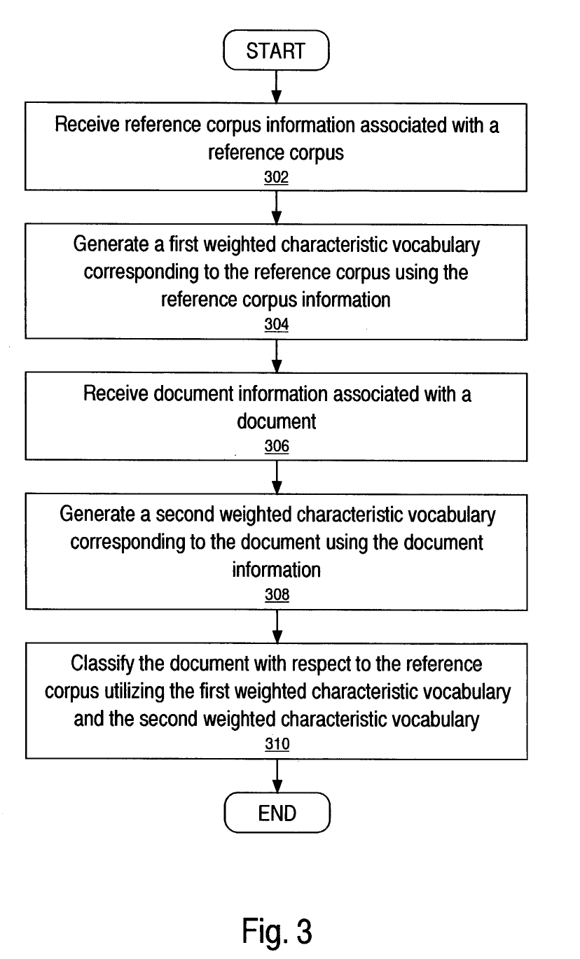

FIG. 3 is a flowchart 300 of steps performed in accordance with embodiments of the present invention for classifying a document with respect to a reference corpus. Flowchart 300 includes processes which, in some embodiments, are carried out by a processor(s) and electrical components under the control of computer readable and computer executable instructions. The computer readable and computer executable instructions may reside, for example, in data storage features such as computer usable volatile memory, computer usable non-volatile memory and/or computer usable mass data storage. However, the computer readable and computer executable instructions may reside in any type of computer readable medium. Although specific steps are disclosed in flowchart 300, such steps are exemplary. That is, the present embodiment is well suited to performing various other steps or variations of the steps recited in FIG. 3. Within the present embodiment, it should be appreciated that the steps of flowchart 300 may be performed by software, by hardware or by any combination of software and hardware.

The present embodiment provides a method for classifying a document (or article) with respect to a reference corpus. For example, when information (e.g., a table of contents, index, etc.) associated with a reference corpus is received (or retrieved), a first weighted characteristic vocabulary is generated using the reference corpus information. It is understood that the first weighted characteristic vocabulary may include, but is not limited to, a determination of the specific words that exist within the reference corpus information along with the number of instances each word exists. Therefore, the first weighted characteristic vocabulary of the reference corpus information may be utilized as a “representation” of the subject matter associated with the reference corpus. Next, when information associated with a document (or article) is received (or retrieved), a second weighted characteristic vocabulary is generated using the document information. It is appreciated that the second weighted characteristic vocabulary of the document information may be utilized as a “representation” of the subject matter associated with the document. Subsequently, the document is classified with respect to the reference corpus utilizing the first weighted characteristic vocabulary and the second weighted characteristic vocabulary.

At step 302 of FIG. 3, reference corpus information corresponding to a reference corpus is received or retrieved in order to be processed by flowchart 300. It is noted that the reference corpus of step 302 is well suited to be implemented in a wide variety of ways. For example, the reference corpus (or large collection of reference materials) may be implemented in any manner similar to that described herein. However, the reference corpus is not limited to these implementations. Additionally, it is understood that the reference corpus information of step 302 is well suited to be implemented in diverse ways. For example, the reference corpus information may be implemented in any manner similar to that described herein. However, the reference corpus information is not limited to these implementations.

In step 304, a first weighted characteristic vocabulary is generated corresponding to the reference corpus utilizing the reference corpus information. It is understood that the weighted characteristic vocabulary of step 304 is well suited to be generated in a wide variety of ways. For example, the generation of the first weighted characteristic vocabulary utilizing the reference corpus information may be implemented in any manner similar to that described herein. However, the generation of the first weighted characteristic vocabulary is not limited in any way to these implementations.

In step 306 of FIG. 3, document information associated with a document (or article) is received or retrieved in order to be processed as illustrated by flowchart 300. It is noted that the document of step 306 is well suited to be implemented in diverse ways in accordance with the present embodiment. For example, the document may be implemented in any manner similar to that described herein. However, the document is not limited to these implementations. Additionally, it is understood that the document information of step 306 is well suited to be implemented in a wide variety of ways. For example, the document information may be implemented in any manner similar to that described herein. However, the document information is not limited to these implementations.

At step 308, a second weighted characteristic vocabulary corresponding to the document is generated utilizing the document information. It is appreciated that the second weighted characteristic vocabulary of step 308 is well suited to be generated in a wide variety of ways. For example, the generation of the second weighted characteristic vocabulary utilizing the document information may be implemented in any manner similar to that described herein. However, the generation of the second weighted characteristic vocabulary is not limited in any way to these implementations.

At step 310 of FIG. 3, the document is classified with respect to the reference corpus utilizing the first weighted characteristic vocabulary and the second weighted characteristic vocabulary. It is appreciated that the step 310 is well suited to be implemented in diverse ways. For example, the document may be classified with respect to the reference corpus utilizing the first weighted characteristic vocabulary and the second weighted characteristic vocabulary in any manner similar to that described herein. However, the classification of the document with respect to the reference corpus at step 310 is not limited in any way to these implementations. Additionally, the document may be classified with respect to the reference corpus at step 310 utilizing any linguistic technique that may involve the first weighted characteristic vocabulary and the second weighted characteristic vocabulary. Once step 310 is completed, the process, in accordance with some embodiments, exits flowchart 300.

It is noted that flowchart 100 and/or flowchart 300 may each be modified to operate in a different manner. For example, flowchart 100 and/or flowchart 300 may be modified to manage work flow within an organization. For instance, within a law firm there may be different people that perform tasks associated within different fields of legal specialization. When a particular task is received by the law firm, a determination is usually made as to who is going to handle it. This decision may be based on all of the other documents that were written by each attorney within the law firm. For example, a weighted characteristic vocabulary may be generated on the documents produced by each attorney. And every time an attorney produces a new document, it may be included as part of that attorney's weighted characteristic vocabulary. Then when an incoming task is received, a weighted characteristic vocabulary may be generated for that task. Subsequently, a “match” may be found between the task and the appropriate attorney by utilizing the respective weighted characteristic vocabulary of each.

Alternatively, within a company, each department may be classified by a generated weighted characteristic vocabulary associated with the products produced by that department or descriptions of those items. Then if something like an advertisement is received by the company, a weighted characteristic vocabulary of it may be generated in order to enable it to be routed to the department most closely related to subject matter of the advertising material.

### EXEMPLARY NETWORK IN ACCORDANCE WITH THE PRESENT INVENTION

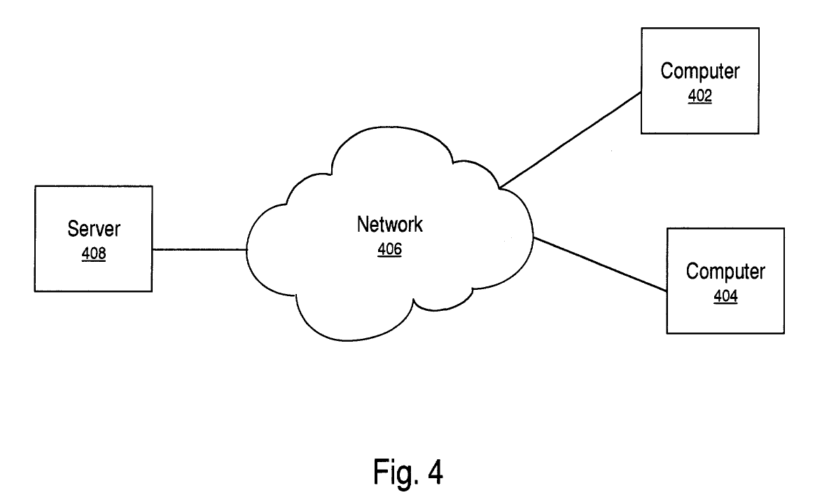

FIG. 4 is a block diagram of an exemplary network 400 that may be utilized in accordance with embodiments of the present invention. For example, computers 402 and 404 may each receive reference corpus information, document information, data associated with documents, data associated with reference corpuses, and the like from a server 408 via a network 406. It is understood that this information may enable computer 402 and/or computer 404 to perform in accordance with an embodiment (e.g., flowchart 100 or flowchart 300) of the present invention.

Within networking environment 400, server 408 and computers 402 and 404 may be coupled in order to communicate. Specifically, server 408 and computers 402 and 404 are communicatively coupled to network 406. It is appreciated that server 408 and computers 402 and 404 may each be communicatively coupled to network 406 via wired and/or wireless communication technologies.

The network 406 of networking environment 400 may be implemented in a wide variety of ways in accordance with the present embodiment. For example, network 406 may be implemented as, but is not limited to, a local area network (LAN), a metropolitan area network (MAN), a wide area network (WAN) and/or the Internet. It is noted that networking environment 400 is well suited to be implemented without network 406. As such, server 408 and computers 402 and 404 may be communicatively coupled via wired and/or wireless communication technologies.

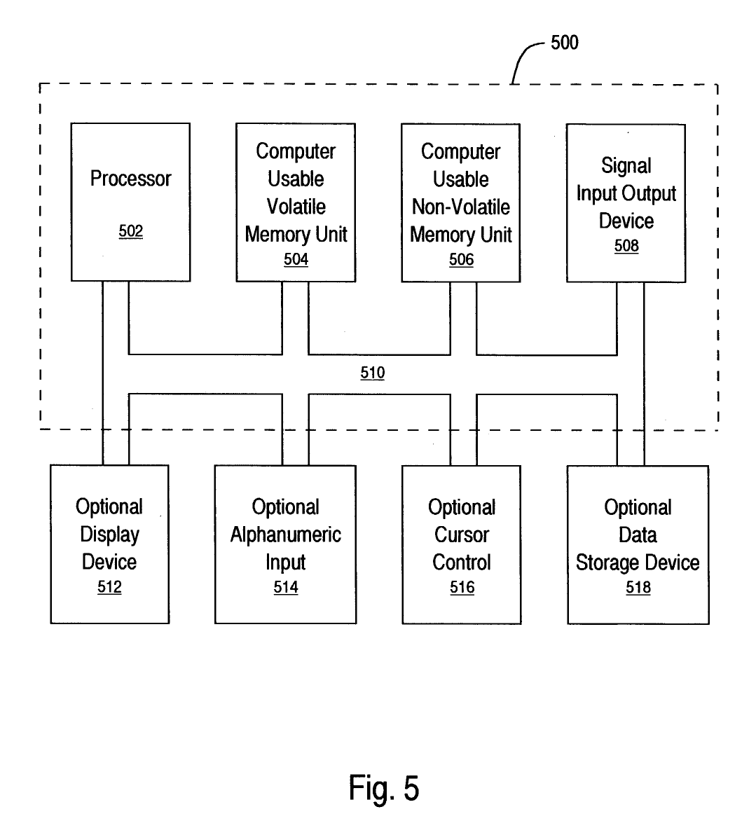

Within FIG. 4, it is understood that networking environment 400 may be implemented to include more or less computers than the two computers (e.g., 402 and 404) shown. Additionally, networking environment 400 may be implemented to include more server devices than the one server device (e.g., 408) shown. It is noted that server 408 and computer 402 and 404 may each be implemented in a manner similar to a computer system 500 of FIG. 5 described herein. However, these devices of networking environment 400 are not strictly limited to such an implementation.

### EXEMPLARY HARDWARE IN ACCORDANCE WITH THE PRESENT INVENTION

FIG. 5 is a block diagram of an exemplary computer system 500 that may be used in accordance with embodiments of the present invention. It is understood that system 500 is not strictly limited to be a computer system. As such, system 500 of the present embodiment is well suited to be any type of computing device (e.g., server computer, desktop computer, laptop computer, portable computing device, etc.). Within the discussions of the present invention herein, certain processes and steps were discussed that may be realized, in one embodiment, as a series of instructions (e.g., software program) that reside within computer readable memory units of computer system 500 and executed by a processor(s) of system 500. When executed, the instructions cause computer 500 to perform specific actions and exhibit specific behavior which is described herein.

Computer system 500 of FIG. 5 comprises an address/data bus 510 for communicating information, one or more central processors 502 coupled with bus 510 for processing information and instructions. Central processor unit(s) 502 may be a microprocessor or any other type of processor. The computer 500 also includes data storage features such as a computer usable volatile memory unit 504, e.g., random access memory (RAM), static RAM, dynamic RAM, etc., coupled with bus 510 for storing information and instructions for central processor(s) 502, a computer usable non-volatile memory unit 506, e.g., read only memory (ROM), programmable ROM, flash memory, erasable programmable read only memory (EPROM), electrically erasable programmable read only memory (EEPROM), etc., coupled with bus 510 for storing static information and instructions for processor(s) 502.

System 500 also includes one or more signal generating and receiving devices 508 coupled with bus 510 for enabling system 500 to interface with other electronic devices. The communication interface(s) 508 of the present embodiment may include wired and/or wireless communication technology. For example, in one embodiment of the present invention, the communication interface 508 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In another embodiment a digital subscriber line (DSL) connection may be employed. In such a case the communication interface(s) 508 may include a DSL modem. It is understood that the communication interface(s) 508 may provide a communication interface to the Internet.

Optionally, computer system 500 can include an alphanumeric input device 514 including alphanumeric and function keys coupled to the bus 510 for communicating information and command selections to the central processor(s) 502. The computer 500 can also include an optional cursor control or cursor directing device 516 coupled to the bus 510 for communicating user input information and command selections to the central processor(s) 502. The cursor directing device 516 can be implemented using a number of well known devices such as a mouse, a track ball, a track pad, an optical tracking device, a touch screen, etc. Alternatively, it is appreciated that a cursor can be directed and/or activated via input from the alphanumeric input device 514 using special keys and key sequence commands. The present embodiment is also well suited to directing a cursor by other means such as, for example, voice commands.

The system 500 of FIG. 5 can also include a computer usable mass data storage device 518 such as a magnetic or optical disk and disk drive (e.g., hard drive or floppy diskette) coupled with bus 510 for storing information and instructions. An optional display device 512 is coupled to bus 510 of system 500 for displaying video and/or graphics. It should be appreciated that optional display device 512 may be a cathode ray tube (CRT), flat panel liquid crystal display (LCD), field emission display (FED), plasma display or any other display device suitable for displaying video and/or graphic images and alphanumeric characters recognizable to a user.

Accordingly, embodiments of the present invention provide a way to more accurately locate relevant documents associated with a particular topic or subject.

The foregoing descriptions of specific embodiments of the present invention have been presented for purposes of illustration and description. They are not intended to be exhaustive or to limit the invention to the precise forms disclosed, and it is evident that many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for classifying a document with respect to a reference corpus, said method comprising:
receiving reference corpus information associated with said reference corpus;
generating a first weighted characteristic vocabulary corresponding to said reference corpus utilizing said reference corpus information;
receiving document information associated with said document;
generating a second weighted characteristic vocabulary corresponding to said document utilizing said document information; and
classifying said document with respect to said reference corpus utilizing said first weighted characteristic vocabulary and said second weighted characteristic vocabulary.

2. The method as described in claim 1, wherein said reference corpus information comprises a table of contents associated with said reference corpus.

3. The method as described in claim 1, wherein said reference corpus information comprises an index associated with said reference corpus.

4. The method as described in claim 1, wherein said reference corpus information is selected from a summary or abstract associated with said reference corpus.

5. The method as described in claim 1, wherein said reference corpus information comprises the contents of said reference corpus.

6. The method as described in claim 1, wherein said document information comprises the contents of said document.

7. The method as described in claim 1, wherein said document information is selected from a table of contents associated with said document, an index associated with said document, a summary associated with said document, or an abstract associated with said document.

8. The method as described in claim 1, wherein said reference corpus is selected from a journal, a collection of periodicals, a collection of magazines, a collection of literature from an author, a collection of literature about a specific subject, or a collection of newspapers from a newspaper publisher.

9. A system for classifying a document with respect to a reference corpus, said system comprising:
means for receiving reference corpus information associated with said reference corpus;
means for creating a first weighted characteristic vocabulary associated with said reference corpus utilizing said reference corpus information;
means for receiving document information associated with said document;
means for creating a second weighted characteristic vocabulary associated with said document utilizing said document information; and
means for classifying said document with respect to said reference corpus utilizing said first weighted characteristic vocabulary and said second weighted characteristic vocabulary.

10. The system as described in claim 9, wherein said reference corpus information comprises a table of contents corresponding to said reference corpus.

11. The system as described in claim 9, wherein said reference corpus information comprises an index corresponding to said reference corpus.

12. The system as described in claim 9, wherein said reference corpus information comprises a summary corresponding to aid reference corpus.

13. The system as described in claim 9, wherein said reference corpus information comprises an abstract corresponding to said reference corpus.

14. The system as described in claim 9, wherein said document information is selected from the contents of said document, a table of contents corresponding to said document, an index corresponding to said document, a summary corresponding to said document, or an abstract corresponding to said document.

15. The system as described in claim 9, wherein said reference corpus is selected from a journal, a collection of periodicals, a collection of magazines, a collection of literature from an author, a collection of literature about a specific subject, or a collection of newspapers from a newspaper publisher.

16. A computer readable medium having computer readable code embodied therein for causing a system to classify a document with respect to a reference corpus, comprising:
retrieving reference corpus information corresponding to said reference corpus;
building a first weighted characteristic vocabulary corresponding to said reference corpus utilizing said reference corpus information;
retrieving document information corresponding to said document;
building a second weighted characteristic vocabulary corresponding to said document utilizing said document information; and
classifying said document with respect to said reference corpus using said first weighted characteristic vocabulary and said second weighted characteristic vocabulary.

17. The computer readable medium as described in claim 16, wherein said reference corpus information comprises a table of contents associated with said reference corpus.

18. The computer readable medium as described in claim 16, wherein said reference corpus information comprises an index associated with said reference corpus.

19. The computer readable medium as described in claim 16, wherein said reference corpus information is selected from a summary associated with said reference corpus or an abstract associated with said reference corpus.

20. The computer readable medium as described in claim 16, wherein said document information is selected from the contents of said document, a table of contents corresponding to said document, an index corresponding to said document, a summary corresponding to said document, or an abstract corresponding to said document.

21. The computer readable medium as described in claim 16, wherein said reference corpus is selected from a journal, a collection of periodicals, a collection of magazines, a collection of literature from an author, a collection of literature about a specific subject, or a collection of newspapers from a newspaper publisher.
